(19) United States
(12) Patent Application Publication
(10) Pub. No.: US 2003/0083820 A1
(43) Pub. Date: May 1, 2003

(54) Extended recursive f-k migration

(76) Inventors: Jiaxiang Ren, Katy, TX (US); Steve Kelly, Houston, TX (US); Ruben D. Martinez, Sugar Land, TX (US)

Correspondence Address: E.EUGENE THIGPEN, PETROLEUM GEO-SERVICES, INC., 16010 BARKER`S POINT LANE, SUITE 600, HOUSTON, TX, 77079, US

(21) Appl. No.: 09/901,490

(22) Filed: Jul. 9, 2001

(51) Int. Cl. G01V 1/28

(52) U.S. Cl. 702/18

(57) ABSTRACT

Recursive f-k migration of a body of seismic data performed in N stages, including establishing from an RMS velocity V_{RMS} a laterally-averaged interval velocity profile extending from a surface at time zero to time t; determining layer boundaries within the laterally averaged interval velocity profile, including identifying a unique set of pairs of depth and vertical travel time giving rise to a minimum sum of squares of residuals for the layers; calculating reference velocities for each layer; time-stretching the entire body of seismic data; performing, upon the data in each layer of the body of seismic data not yet fully migrated, recursive stages of f-k migration, including using as input to a current recursive migration stage that portion of the output from a previous recursive migration stage that comprises data partially migrated; and inversely time-stretching the entire body of seismic data.

### BACKGROUND OF THE INVENTION

Stolt (1978) method of f-k migration (frequency-wavenumber migration), incorporated herein by reference, as originally formulated, is known to be the fastest migration algorithm for 3D data volumes. However, the Stolt method requires that the acoustic velocity be constant throughout the propagation media. In order to accommodate lateral and vertical velocity variations, Stolt (1978) developed a strategy for “mimicking” constant velocity by time-stretching the data relative to a constant reference velocity. He also revised and then simplified the dispersion relation to reflect this stretch. The resulting equation contains an “adjustment factor,” W, that compensates for the stretch. The W factor defined by Stolt (1978) is a complicated function of time and space and cannot be exactly computed. In practice, a constant W based on heuristic guess is used in f-k migration. Fomel (1995, 1999), incorporated herein by reference, introduced a straight forward analytic technique for estimating W(t) from a velocity profile. However, only an average value can be used in an f-k migration, since the algorithm is performed in the frequency-wavenumber domain.

Regardless of the method by which the W is selected, f-k migration with data stretching is inaccurate for steep dips in the presence of vertical velocity variations. This is due to the fact that the method does not account for ray bending (Mikulich and Hale, 1992, incorporated herein by reference). In addition, since a constant W factor is used in the migration, the result is correct only for a very limited time range; events at earlier or later times are either over-migrated or under-migrated (Beasley et al., 1988, incorporated herein by reference). These are serious shortcomings that can be overcome to some extent in the following ways.

In one of the method to overcome foregoing shortcomings a series of constant-velocity migrations are performed using RMS velocities and the results are interpolated versus time and lateral position. One thus “carves out” from the suite of 3D migrations a final, 3D volume that corresponds to the best migration at each position and time. This can also be an effective tool for pre-stack velocity estimation (Li et al., 1991, incorporated herein by reference). Unfortunately, the optimum migration velocity may differ significantly from the RMS velocity due to ray bending. The “carving” thus requires an interactive display and editing tools, since it is not viable for ‘a priori’ RMS velocity functions.

In another approach the ray bending effect in the f-k migration is implicitly accounted for through the use of dip-dependent velocities in the time-variable velocity function. This method was developed by Mikulich and Hale (1992), incorporated herein by reference. Unfortunately, this approach requires an inordinate computational effort.

In a yet another approach Beasley, U.S. Pat. No. 4,888,742, incorporated herein by reference, devised a scheme in which he handled a time-variable velocity function by decomposing the migration into a series of constant-velocity migrations. The migrations are thus performed in a recursive, multi-stage fashion, stripping away the portion that is completely migrated in each run. All of the sections that underlie the current stage are thus partially migrated during each migration. Velocity variation is accommodated by stretching the data relative to the constant velocity for the current stage. Ray bending is thus accommodated through the repetitive use of different residual velocities for a given time or depth interval. After each current stage has been migrated, the data are unstretched. A new stretch is then applied that is appropriate for the next migration stage. The repeated time stretching and unstretching is computationally highly burdensome.

Kim et al. (1989, 1997), incorporated herein by reference, developed another method for post-stack and pre-stack migration. In this approach Kim et al. approximate a time-variable velocity function with a coarsely-sampled, stepwise representation. The stepwise function is generated by computing a depth-time curve for vertical propagation and then approximating the curve with a set of contiguous, straight-line segments. The migration is performed in a recursive fashion, with each stage using a constant velocity. The advantages of this method are its speed and simplicity, since the data are not stretched prior to each stage. However, there is no correction for the difference between the true velocity function and its stepwise approximation. Furthermore, the method is inefficient in that it discards, for each stage, the partially migrated wavefield that lies beneath the stage that has just been fully migrated. Each stage is thus migrated using the total migration velocity for that stage. In order to prepare the wavefield for migration of the next stage, a redatuming is performed simply by a phase shift. The accommodation of ray bending is thus effected through an additional, recursive, redatuming step. This approach for handling the ray bending is computationally intensive and wasteful.

Therefore there is a continuing need for developing a method of migration that can account for ray bending and is computationally efficient.

### SUMMARY

In summary, this specification discloses recursive f-k migration of a body of seismic data performed in N stages, including establishing from an RMS velocity V_{RMS} a laterally-averaged interval velocity profile extending from a surface at time zero to time t; determining layer boundaries within the laterally averaged interval velocity profile, the layer boundaries identified as vertical travel times t₁ . . . t_{N}, for N layers, the said determining further comprising identifying a unique set of pairs of depth and vertical travel time giving rise to a minimum sum of squares of residuals for the N layers; the layer boundaries defining layers within the laterally averaged interval velocity profile and within the body of seismic data, the jth layer within the body of seismic data containing the portion of seismic data having vertical travel times between tⱼ₋₁ and tⱼ; calculating reference velocities, the reference velocities including one reference velocity for each of the N layers, the reference velocities designated as V₁^{ref} . . . Vₙ^{ref}; stretching the entire body of seismic data according to a stretch equation of:

$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′} ;$$

performing, upon the data in each layer of the body of seismic data not yet fully migrated, recursive stages of f-k migration, including using as input to a current recursive migration stage that portion of the output from a previous recursive migration stage that comprises data partially migrated, further including using for the migration velocity for a jth recursive migration stage a migration velocity defined as Vⱼ^{mig}=((Vⱼ^{ref})²−(Vⱼ₋₁^{ref})²)^{½}; further including repeatedly performing recursive stages of f-k migration until the entire body of seismic data is fully migrated; and inversely stretching the entire body of seismic data according to the stretch equation.

Typical embodiments include reading an ensemble of data having constant wave number, the data in the ensemble comprising trace data from a multiplicity of traces, the data in the ensemble comprising sample values of pressure as a function of wave number and time, the time parameter being sample times having intervals when sample values were acquired. Typical embodiments include performing on the padded trace data a jth stage of recursive f-k migration using as a migration velocity for the jth stage Vⱼ^{mig}, wherein a first portion of the seismic data is fully migrated and a second portion of the seismic data is partially migrated.

Typical embodiments include stripping from the migrated trace data the first, fully migrated, portion of the migrated trace data. Typical embodiments include shifting earlier in time the second, partially migrated, portion of the migrated trace data. In typical embodiments, stretching the entire body of seismic data according to the stretch equation includes generating interpolation coefficient tables comprising interpolation coefficients tabulated for a pre-selected set of positions, δn; generating a time stretch table, the time stretch table comprising values of stretch time T tabulated according to unstretched time t and V_{RMS}; and using the time stretch tables and interpolating a value of P(kₓ,k_{y},t) at an intermediate time position between two sample times for unstretched trace data.

In typical embodiments, inversely stretching the entire body of seismic data according to the stretch equation includes using the time stretch tables and interpolating a value of P(kₓ,k_{y},T) at an intermediate time position between two stretch times for stretched, migrated trace data. In typical embodiments, the establishing from an RMS velocity V_{RMS} a laterally-averaged interval velocity profile extending from the surface at time zero to time t includes re-sampling the RMS velocity profiles in a seismic survey in a vertical travel time dimension with a specified interval; on each of a multiplicity of sample point levels, averaging RMS velocities from all velocity profiles on each sample point level, resulting in a laterally-averaged RMS velocity profile; converting the averaged RMS velocity on each sample point into the interval velocity according to:

Vₙ=(TₙVₙ²−(Tn−1)²)/(Tₙ−Tₙ₋₁),

where Vₙ and Vₙ₋₁ are average velocities from the surface to the bottom of layers “n” and “n−1,” respectively.

In typical embodiments, determining layer boundaries includes integrating the laterally-averaged interval velocity profile to obtain a computed depth for each measured vertical travel time in the body of seismic data, the computed depth and the measured vertical travel time for which the computed depth is computed comprising a depth-travel time pair, grouping the depth-travel time pairs into N candidate subdivisions identified by candidate layer boundaries; calculating linearly-fitted depths by applying linear regression over each of the N candidate subdivisions, computing the sum of the squares of the residuals between the computed depths and the linearly-fitted depths; and identifying a unique set of layer boundaries that gives rise to a minimum sum of squares of residuals for the N subdivisions by iterating over a subset of all possible such sets of candidate subdivisions identified by candidate layer boundaries.

In typical embodiments, the choosing a breakpoint configuration includes generating stage configurations for all possible combinations of measured vertical travel time and depth; and searching the generated stage configurations for a stage configuration comprising the minimum value for an objective function expressed as:

Φ(m,S,E)=^{m}Σₖ₌₁^{E(k)}Σⱼ₌ₛ₍ₖ₎[Tⱼ−T′(zⱼ)]²

wherein Tⱼ is the true two-way travel time to depth Zⱼ and T′(zⱼ) is a linearly-fitted two-way travel time from a linear regression of depth versus vertical travel time.

In typical embodiments, calculating reference velocities includes integrating the laterally-averaged interval velocity profile to obtain a computed depth for each measured vertical travel time in the body of seismic data, the computed depth and the measured vertical travel time for which the computed depth is computed comprising a depth-travel time pair, grouping the depth-travel time pairs into N layers identified by layer boundaries; calculating linearly-fitted depths by applying linear regression over each of the N layers, and calculating for each of the N layers a reference velocity as a slope of a function defined by linearly-fitted depth-travel time pairs for each layer.

In typical embodiments, generating interpolation coefficient tables includes specifying a number of pre-selected sample points in a sample interval and an interpolation filter length; on each pre-selected sample point, determining the fractional sample interval δn such that 0.0<=δn<=1.0; calculating an interpolation coefficient for each specified sample point, including using an analytical interpolation filter comprising a windowed sinc filter, the interpolation filter having an interpolation filter length; and storing the calculated interpolation coefficients in a two-dimensional table, with the length of the first dimension being the number of pre-selected positions and the length of the second dimension being the interpolation filter length.

In typical embodiments, generating a time stretch table includes generating a table of RMS velocities V_{RMS}, unstretched time t, and stretched time T according to:

$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′}$$

where t is an unstretched vertical travel time, T is a stretched time corresponding to an unstretched vertical travel time, t′ is a variable of integration, V_{RMS}^{ref} is an RMS velocity corresponding to a laterally-averaged interval velocity, and V_{RMS} is an RMS velocity corresponding to a true interval velocity.

In typical embodiments, stretching the entire body of seismic data includes for a first sample stretched time and an RMS velocity in an integral sample interval, wherein the first sample stretched time has a value falling between integral sample points, finding in the time stretch table a corresponding unstretched time t, wherein the corresponding unstretched time does fall precisely upon an integral sample point; and obtaining a second sample stretched time interpolating using the interpolation coefficient table in dependence upon the corresponding unstretched time; and assigning the value of the second sample stretched time obtained by the interpolation as an actual stretched time value.

In typical embodiments, performing an f-k migration includes determining ωₘᵢₙ and ωₘₐₓ; determining \overline{ω}ₘᵢₙ and \overline{ω}ₘₐₓ, wherein there are a finite number of \overline{ω}'s between \overline{ω}ₘᵢₙ and \overline{ω}ₘₐₓ; and performing for each \overline{ω} between \overline{ω}ₘᵢₙ and \overline{ω}ₘₐₓ the steps of computing ω as a function of \overline{ω}, performing windowed sinc interpolation to get Pₘ(\overline{ω}), and scaling Pₘ(\overline{ω}). In typical embodiments, stripping the fully migrated portion of the migrated trace data includes concatenating a fully migrated portion of trace data from a stage of recursive migration with the fully migrated data from previous stages of recursive migration.

In typical embodiments, inversely stretching the entire body of seismic data includes for an unstretched time on an integral sample interval, finding in the time stretch table a corresponding stretched time, based on the combination of interval velocity and unstretched time in the data; obtaining the sample value at the stretched time, wherein the sample value falls between integral sample points, further comprising interpolating by use of the interpolation coefficient tables; and assigning the value obtained by the interpolation as an unstretched time.

### BRIEF DESCRIPTION OF THE DRAWINGS

FIG. 1 shows a schematic of interval velocity and its approximated stage velocities.

FIG. 2 shows an illustration of recursive migration.

FIG. 3 shows an illustration of the process to manually determine stepwise velocity wherein:

FIG. 3a shows a hypothetical interval velocity profile,

FIG. 3b shows T-Z curve and its piecewise linear approximation, and

FIG. 3c shows comparison of original and approximated interval velocities.

FIG. 4 shows a schematic illustration of trace stretching.

FIG. 5 presents a process flow diagram of exemplary embodiments.

### DETAILED DESCRIPTION OF EXAMPLARY EMBODIMENTS

The present invention is described primarily in terms of methods for migration of seismic data. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

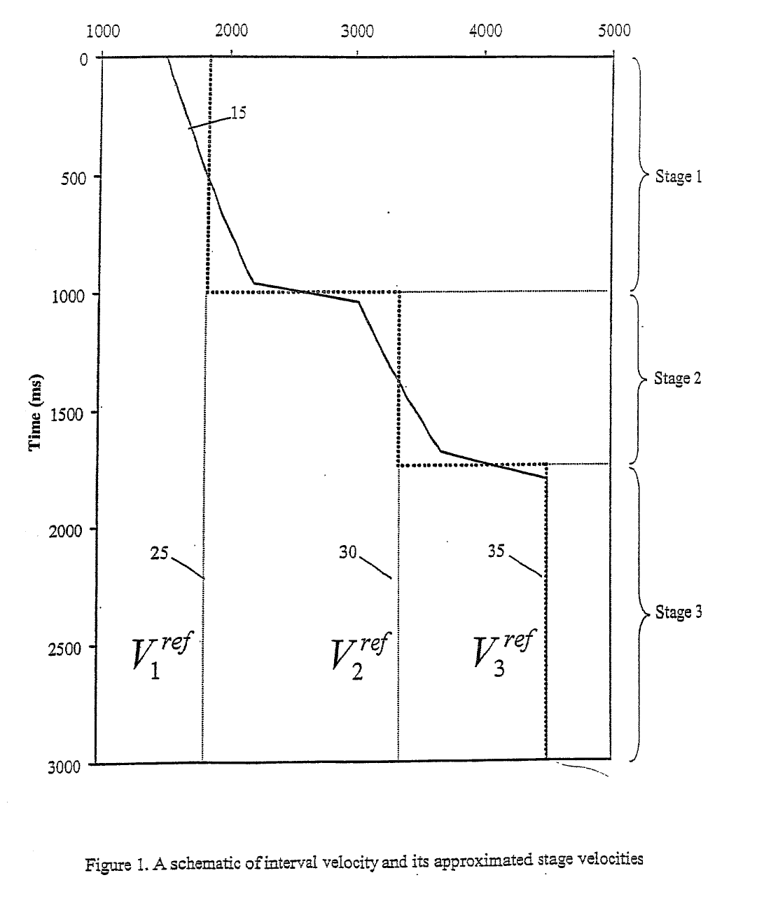

Referring to FIGS. 1 through 4, in one embodiment of the present invention, a method of migrating seismic event data in the presence of a vertically time-varying velocity field defined by a migration velocity function is provided.

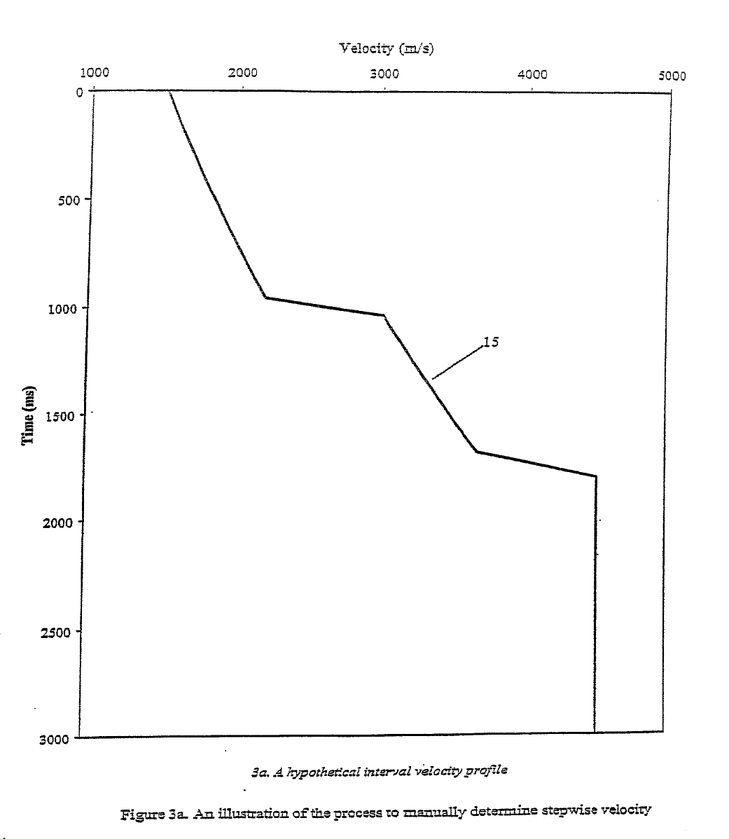

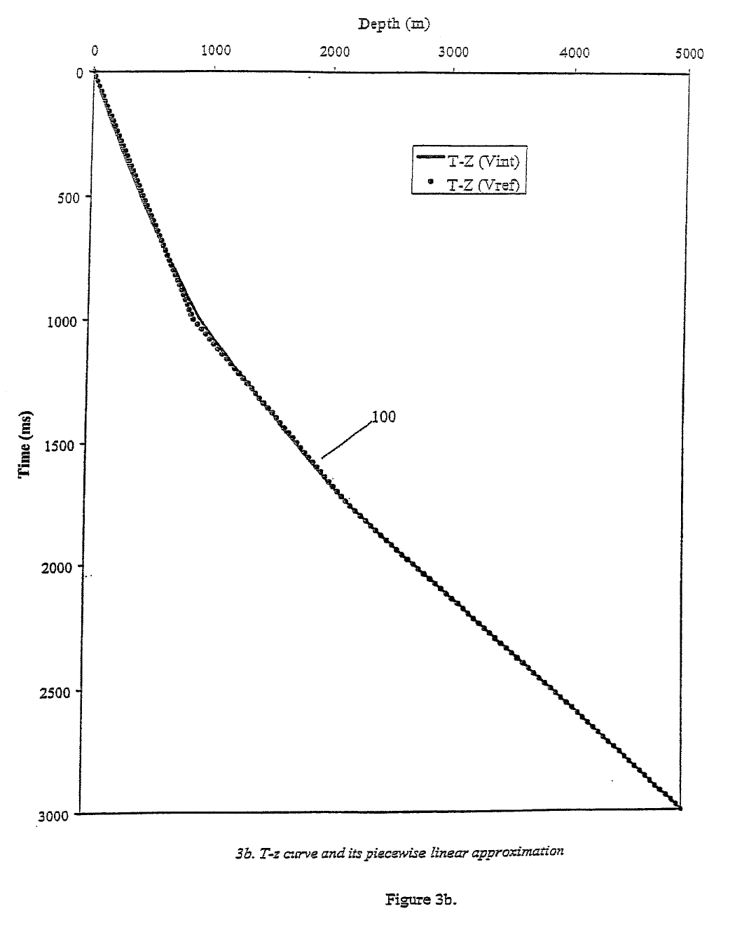

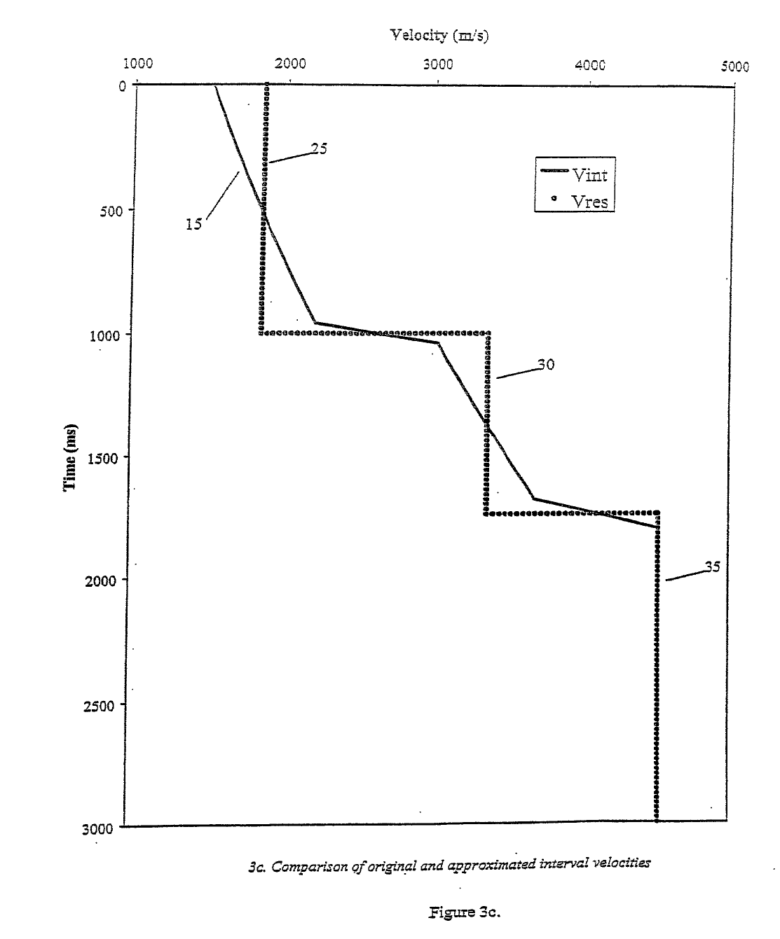

FIGS. 1 illustrates an example migration velocity function 15 wherein it is desired to migrate a seismic event data 50 in the presence of a vertically time-varying velocity field. For illustration purposes the migration velocity function 15 is approximated by only three constant stepwise stage velocities V₁^{ref}25, V₂^{ref}30, and V₃^{ref} 35 for corresponding stages 1 through 3. However, the migration velocity function 15 can be approximated by any desired number of constant stepwise stage velocities. The boundaries of stages can be determined either manually or automatically as described later in more detail. FIGS. 3a through 3c illustrate the process of reduction of a hypothetical interval velocity profile into constant stepwise stage velocities that comprise the migration velocity function 15.

FIG. 3a shows a hypothetical interval velocity profile 15. FIG. 3b shows T-Z curve and its piecewise linear approximation 100. FIG. 3c shows the resulting constant stepwise stage velocities 25, 30, 35 of the hypothetical example superimposed on the hypothetical interval velocity profile 15.

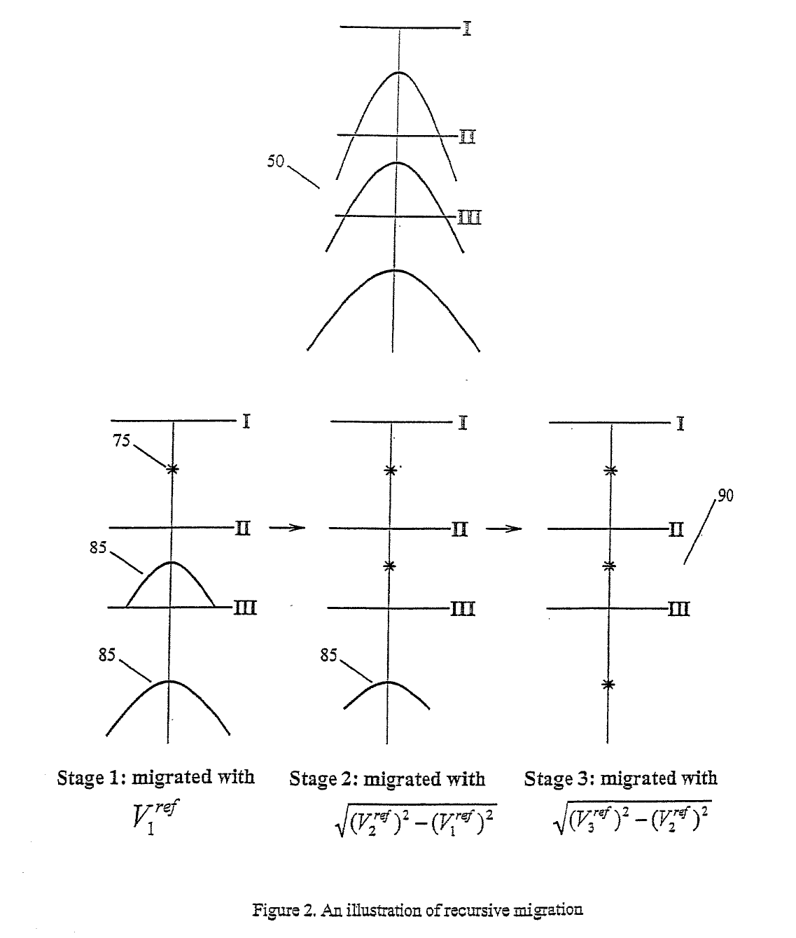

In FIG. 2 the seismic event 50 is divided into only three stages for illustration of the successive migration method of the invention to be described in the following paragraphs. FIG. 2 further shows progression of the migration process through the illustrated three migration stages.

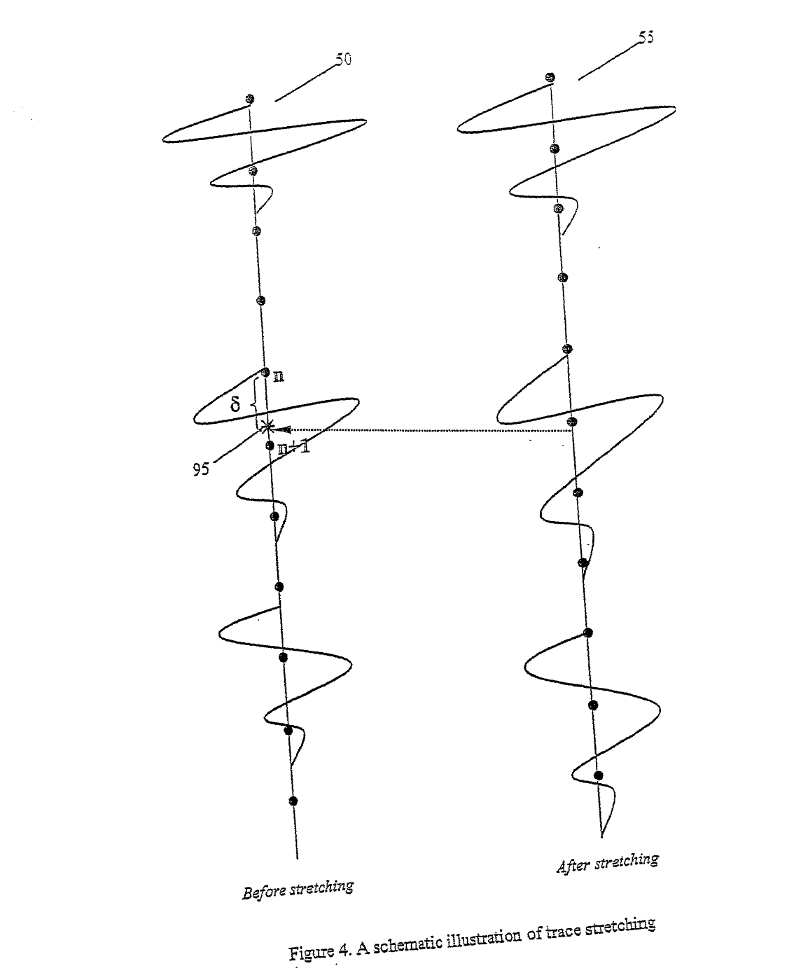

FIG. 4 shows a schematic illustration of time stretching of the before stretching seismic event data 50 into the time-stretched seismic event data 55. FIG. 4 also shows interpolation of a data point 95 lying between two sampled data points, which can be done by, for example, using a sinc filter with a Hamming window, and using other interpolation techniques that would occur to those skilled in the art.

Now referring to FIGS. 1 through 4, an embodiment of the method of migrating seismic event data 50 in the presence of a vertically time-varying velocity field defined by a migration velocity function 15 is provided. The method comprises: approximating the migration velocity function 15 by constant stepwise stage velocities V₁^{ref} 25, V₂^{ref}30, . . . , Vₙ^{ref} for stages 1 through n; time stretching the seismic event data 50 to compensate for approximating the migration velocity function by constant stepwise stage velocities, wherein a 1^{st} set of data comprising time-stretched seismic event data 55 for stages 1 through n results; migrating the 1^{st} set of data using a migration algorithm, for example, f-k migration, finite difference migration, Kirchhoff migration, and other that would occur to one skilled in the art, and using the migration velocity V₁^{ref}25, wherein stage 1 fully migrated data 75 results, and wherein a 2^{nd} set of data 85 comprising partially migrated data for stages 2 through n results; successively migrating kₜₕ through nₜₕ set of data 85 using the migration algorithm and using a residual migration velocity that is a function of Vₖ^{ref} and Vₖ₋₁^{ref}, for k=2,3 . . . , n respectively, wherein the kₜₕ set of data comprises partially migrated data for stages k through n resulting after migrating the (k−1)ₜₕ set of data, and wherein stages k through n migrated data 90 result; and time unstretching the stages 1 through n migrated data 90, wherein a seismic event migrated data results.

In another embodiment of the method, the migration velocity function 15 comprises acoustic velocity in the media as a function of time. In a yet another embodiment the stages 1 through n are manually defined from the migration velocity function 15 as the operator may decide. In a still another embodiment boundaries of the stages 1 through n are defined by minimizing a function of the migration velocity function 15 and the constant stepwise stage velocities 25, 30, 35 . . . n. In a yet still another embodiment boundaries of the stages 1 through n are defined by minimizing an objective function comprising difference between travel time corresponding to the migration velocity function 15 and computed travel time corresponding to the constant stepwise stage velocities 25, 30, 35 . . . n. In a still further embodiment the objective function comprises:

$$Φ ( m , S , E ) = {\sum }_{k = 1}^{m} {\sum }_{j = S ( k )}^{E ( k )} {[ {T}_{j} - {T}^{′} ( {z}_{j} ) ]}^{2} ,$$

where Tⱼ is the true two-way time to depth Zⱼ, and T′(Zⱼ) is the interpolated two-way time from regression, m is the number of stages, S and E are m-length vectors of indices for the top and bottom of the stages.

In a further still another embodiment the constant stepwise stage velocities 25, 30, 35 . . . n comprise stage interval values of the migration velocity function 15 defined for stages 1 through n. In a further still yet another embodiment the time stretching comprises time stretching the seismic event data according to following equation:

$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′} \qquad ( 1 )$$

where t is the unstretched time, T is the corresponding stretched time, V_{RMS}^{ref}(t) is the RMS velocity of the approximated, constant stepwise stage velocities 25, 30 . . . n, and V_{RMS}(t) is the corresponding RMS velocity of a true interval velocity function. The

$${V}_{RMS}^{ref} ( t )$$

and V_{RMS}(t) are calculated by:

$$\begin{matrix}{[ {V}_{RMS}^{ref} ( t ) ]}^{2} = \frac{1}{t} {\int }_{0}^{t} {[ {V}^{ref} ( {t}^{′} ) ]}^{2} ⅆ {t}^{′} \\ and & ( 2 ) \\ \begin{matrix}{[ {V}_{RMS} ( t ) ]}^{2} = \frac{1}{t} {\int }_{0}^{t} {[ V ( {t}^{′} ) ]}^{2} ⅆ {t}^{′} . & \end{matrix} & ( 3 )\end{matrix}$$

In a yet still another embodiment a data point lying between two sampled data points is interpolated using a sinc filter with a Hamming window. The sinc filter and the Hamming window are well known in the art (Harlan (1982), Smith (1997)). Other filters with different window functions can be used in place of the sinc filter and the Hamming window as would occur to one skilled in the art. In a still another embodiment the migration algorithm comprises Stolt (also known as f-k) algorithm. In an alternate embodiment the migration algorithm for migrating the 1^{st} set of data and the migration algorithm for successively migrating kₜₕ through nₜₕ set of data are different migration algorithms, for example, one can select f-k migration, finite difference migration, or Kirchhoff migration algorithm for migrating the 1^{st} set of data and can select f-k migration, finite difference migration, or Kirchhoff migration algorithm for successively migrating kₜₕ through nₜₕ set of data, and other combinations and permutations of migration algorithms as would occur to one skilled in the art. In another alternate embodiment the residual migration velocity is equal to SQRT((Vₖ^{ref})²−(Vₖ₋₁^{ref})²), for k=2,3 . . . , n, wherein k represents the stage number. In a yet another alternate embodiment wherein the time unstretching comprises applying operation to reverse the effect of time stretching of equation (1). In a still further alternate embodiment steps (b) through (e) of claim 1 are repeated for migrating each of a plurality of seismic events 50.

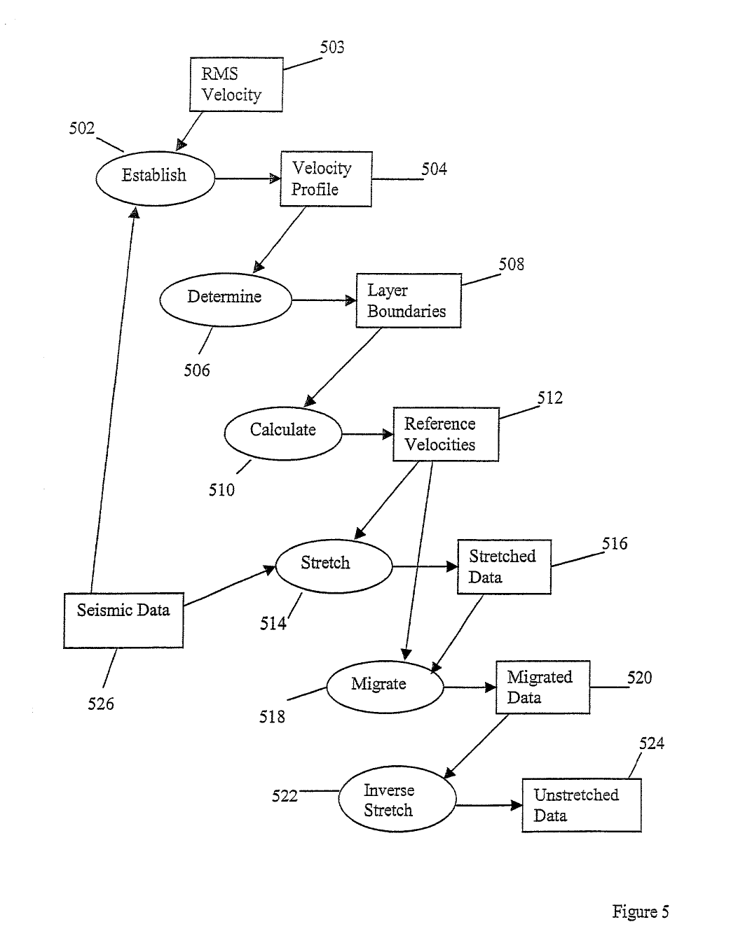

Turning now to FIG. 5, a further embodiment of the invention is illustrated as a method of recursive f-k migration of a body of seismic data (526) performed in N stages. In typical embodiments, the number of stages N corresponds to the number of layers in which the body of seismic data is migrated, and the number N is established by any method known in the art, including, for example, manual inspection of preliminary displays of unmigrated data or manual selection based on past experience. The illustrated embodiment of FIG. 5 begins by establishing (502) from an RMS velocity (503) V_{RMS} a laterally-averaged interval velocity profile (504) extending from a surface at time zero to time t.

The illustrated embodiment includes determining (506) layer boundaries (508) within the laterally averaged interval velocity profile, the layer boundaries identified as vertical travel times t₁ . . . t_{N}, for N layers. Determining layer boundaries in typical embodiments includes identifying a unique set of pairs of depth and vertical travel time giving rise to a minimum sum of squares of residuals for the N layers. In typical embodiments, the layer boundaries define layers within the laterally averaged interval velocity profile and within the body of seismic data, the jth layer within the body of seismic data containing the portion of seismic data having vertical travel times between tⱼ₋₁ and tⱼ.

Typical embodiments of the kind illustrated in FIG. 5, include calculating (510) reference velocities (512). The reference velocities typically include one reference velocity for each of the N layers. In the example embodiment under discussion, the reference velocities are designated as V₁^{ref} . . . Vₙ^{ref}. Typical embodiments of the kind illustrated in FIG. 5, include stretching (514) the entire body of seismic data (526) according to a stretch equation of:

$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′} ,$$

where t is an unstretched vertical travel time, T is a stretched time corresponding to an unstretched vertical travel time, t′ is a variable of integration, V_{RMS}^{ref} is an RMS velocity corresponding to a laterally-averaged interval velocity, and V_{RMS} is an RMS velocity corresponding to a true interval velocity.

Typical embodiments of the kind illustrated in FIG. 5, include performing, upon the data in each layer of the body of seismic data not yet fully migrated (516), recursive stages of f-k migration (518). In typical embodiments, the recursive migration includes using as input to a current recursive migration stage that portion of the output from a previous recursive migration stage that comprises data partially migrated. In typical embodiments, the recursive migration includes using for the migration velocity for a jth recursive migration stage a migration velocity defined as Vⱼ^{mig}=((Vⱼ^{ref})²−(Vⱼ₋₁^{ref})²)^{½}. In typical embodiments, the recursive stages of f-k migration are performed repeatedly until the entire body of seismic data is fully migrated. Typical embodiments of the kind illustrated in FIG. 5 include inversely stretching (522) the entire body of seismic data according to the stretch equation, resulting in the production of fully migrated and unstretched seismic data (524).

Typical embodiments of the kind illustrated in FIG. 5 include reading an ensemble of data having constant wave number, the data in the ensemble comprising trace data from a multiplicity of traces, the data in the ensemble comprising sample values of pressure as a function of wave number and time, the time parameter being sample times having intervals when sample values were acquired.

Typical embodiments of the kind illustrated in FIG. 5 include stripping from the migrated trace data the first, fully migrated, portion of the migrated trace data and shifting earlier in time the second, partially migrated, portion of the migrated trace data.

In typical embodiments of the kind illustrated in FIG. 5, stretching the entire body of seismic data according to the stretch equation includes generating interpolation coefficient tables comprising interpolation coefficients tabulated for a pre-selected set of positions, δn; generating a time stretch table, the time stretch table comprising values of stretch time T tabulated according to unstretched time t and V_{RMS}; and using the time stretch tables and interpolating a value of P(kₓ,k_{y},t) at an intermediate time position between two sample times for unstretched trace data. In typical embodiments of the kind illustrated in FIG. 5, inversely stretching the entire body of seismic data according to the stretch equation includes using the time stretch tables and interpolating a value of P(kₓ,k_{y},T) at an intermediate time position between two stretch times for stretched, migrated trace data.

In typical embodiments of the kind illustrated in FIG. 5, establishing from an RMS velocity V_{RMS} a laterally-averaged interval velocity profile extending from the surface at time zero to time t includes re-sampling the RMS velocity profiles in a seismic survey in a vertical travel time dimension with a specified interval; on each of a multiplicity of sample point levels, averaging RMS velocities from all velocity profiles on each sample point level, resulting in a laterally-averaged RMS velocity profile; and converting the averaged RMS velocity on each sample point into the interval velocity according to the following formula, which is referred to in this specification as the “Dix formula,” after C. H. Dix's “Seismic Velocities from Surface Measurements,” Geophysics, Vol. 20, No. 1, p.73 (1955). The Dix formula is:

Vₙ=(TₙVₙ²−(Tn−1)²)/(Tₙ−Tₙ₋₁),

where Vₙ and Vₙ₋₁ are average velocities from the surface to the bottom of layers “n” and “n−1,” respectively. The two-way travel times from the surface to the bottom of each layer are Tₙ and Tₙ₋₁. In typical embodiments, the Dix formula enables the inference of the interval velocity for the nth layer, Vₙ, from this information. The interval velocity typically is considered constant over the layer. It is typical also to assume that estimates of Vₙ and Vₙ₋₁ are well-approximated by the RMS velocity estimates as obtained from hyperbolic velocity analysis.

In typical embodiments of the present invention, true, rather than optimally fitted interval velocity Vₙ is extracted from input average or RMS velocities. This extraction is typically accomplished by use of the Dix formula. It is the resulting profile of Vₙ versus time (or depth) that is then typically used to obtain a depth versus time curve.

In typical embodiments of the kind illustrated in FIG. 5, determining layer boundaries includes integrating the laterally-averaged interval velocity profile to obtain a computed depth for each measured vertical travel time in the body of seismic data, the computed depth and the measured vertical travel time for which the computed depth is computed comprising a depth-travel time pair, grouping the depth-travel time pairs into N candidate subdivisions identified by candidate layer boundaries; calculating linearly-fitted depths by applying linear regression over each of the N candidate subdivisions, computing the sum of the squares of the residuals between the computed depths and the linearly-fitted depths; and identifying a unique set of layer boundaries that gives rise to a minimum sum of squares of residuals for the N subdivisions by iterating over a subset of all possible such sets of candidate subdivisions identified by candidate layer boundaries. The subset of all possible sets of subdivisions is found through ‘dynamic programming.’ Exhibit II of this specification sets forth example pseudocode illustrating typical embodiments of dynamic programming for determining all possible sets of subdivisions. The example of dynamic programming set forth in Exhibit II is an example of a way of determining layer boundaries. Other ways of determining layer boundaries will occur to those of skill in the art, all such ways being well within the scope of the present invention.

In typical embodiments of the kind illustrated in FIG. 5, choosing a breakpoint configuration includes generating stage configurations for all possible combinations of measured vertical travel time and depth; and searching the generated stage configurations for a stage configuration comprising the minimum value for an objective function expressed as:

Φ(m,S,E)=^{m}Σₖ₌₁^{E(k)}Σⱼ₌ₛ₍ₖ₎[Tⱼ−T′(zⱼ)]²

wherein Tⱼ is the true two-way travel time to depth Zⱼ and T′(zⱼ) is a linearly-fitted two-way travel time from a linear regression of depth versus vertical travel time. Regression is used in typical embodiments to determine the migration velocity, even in embodiments that typically utilize only one stage of recursive f-k migration. In most embodiments, the slope of the linear regression of depth versus time is taken as the migration velocity.

In typical embodiments of the kind illustrated in FIG. 5, calculating reference velocities includes integrating the laterally-averaged interval velocity profile to obtain a computed depth for each measured vertical travel time in the body of seismic data, the computed depth and the measured vertical travel time for which the computed depth is computed comprising a depth-travel time pair, grouping the depth-travel time pairs into N layers identified by layer boundaries; calculating linearly-fitted depths by applying linear regression over each of the N layers, and calculating for each of the N layers a reference velocity as a slope of a function defined by linearly-fitted depth-travel time pairs for each layer.

In typical embodiments of the kind illustrated in FIG. 5, generating interpolation coefficient tables includes specifying a number of pre-selected sample points in a sample interval and an interpolation filter length; on each pre-selected sample point, determining the fractional sample interval δn such that 0.0<=δn<=1.0; calculating an interpolation coefficient for each specified sample point, including using an analytical interpolation filter comprising a windowed sinc filter, the interpolation filter having an interpolation filter length; and storing the calculated interpolation coefficients in a two-dimensional table, with the length of the first dimension being the number of pre-selected positions and the length of the second dimension being the interpolation filter length.

In typical embodiments of the kind illustrated in FIG. 5, generating a time stretch table includes generating a table of RMS velocities V_{RMS}, unstretched time t, and stretched time T according to:

$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′}$$

where t is an unstretched vertical travel time, T is a stretched time corresponding to an unstretched vertical travel time, t′ is a variable of integration, V_{RMS}^{ref} is an RMS velocity corresponding to a laterally-averaged interval velocity, and V_{RMS} is an RMS velocity corresponding to a true interval velocity.

In typical embodiments of the kind illustrated in FIG. 5, stretching the entire body of seismic data includes for a first sample stretched time and an RMS velocity in an integral sample interval, wherein the first sample stretched time has a value falling between integral sample points, finding in the time stretch table a corresponding unstretched time t, wherein the corresponding unstretched time does fall precisely upon an integral sample point; obtaining a second sample stretched time interpolating using the interpolation coefficient table in dependence upon the corresponding unstretched time; assigning the value of the second sample stretched time obtained by the interpolation as an actual stretched time value.

In typical embodiments of the kind illustrated in FIG. 5, performing an f-k migration includes determining ωₘₘ, and ωₘₐₓ; determining \overline{ω}ₘᵢₙ and \overline{ω}ₘₐₓ, wherein there are a finite number of \overline{ω}'s between \overline{ω}ₘᵢₙ and \overline{ω}ₘₐₓ; and performing for each \overline{ω} between \overline{ω}ₘᵢₙ and \overline{ω}ₘₐₓ the steps computing ω as a function of \overline{ω}; performing windowed sinc interpolation to get Pₘ(\overline{ω}); and scaling Pₘ(\overline{ω}). In typical embodiments of the kind illustrated in FIG. 5, stripping the fully migrated portion of the migrated trace data includes concatenating a fully migrated portion of trace data from a stage of recursive migration with the fully migrated data from previous stages of recursive migration. In typical embodiments of the kind illustrated in FIG. 5, the migrated trace is obtained after stripping and concatenating the fully migrated portion from the last stage of migration.

In typical embodiments of the kind illustrated in FIG. 5, inversely stretching the entire body of seismic data includes for an unstretched time on an integral sample interval, finding in the time stretch table a corresponding stretched time, based on the combination of interval velocity and unstretched time in the data; obtaining the sample value at the stretched time, wherein the sample value falls between integral sample points, further comprising interpolating by use of the interpolation coefficient tables; and assigning the value obtained by the interpolation as an unstretched time.

As a further aid to understanding, the following more detailed description of example embodiments is provided:

Typical embodiments of the present invention include methods of recursive f-k migration performed in more than one stage of partial migration. Typical embodiments of the present invention include establishing a laterally averaged interval velocity profile of RMS velocity V_{RMS} from the surface to time t. Typical embodiments of the present invention include determining layer boundaries within the velocity profile, t₁ . . . tₙ, for n layers. Typical embodiments of the present invention include calculating reference velocities V₁^{ref} . . . Vₙ^{ref}, one for each of the n layers.

Typical embodiments of the present invention include generating interpolation coefficient tables comprising interpolation coefficients tabulated for a pre-selected set of positions, δn. Typical embodiments of the present invention include generating a time stretch table, the time stretch table comprising values of stretch time T tabulated according to unstretched time t and V_{RMS}.

Typical embodiments of the present invention include reading an ensemble of data having constant wave number (Kₓ or K_{y}), the data in the ensemble comprising trace data from a multiplicity of traces, the data in the ensemble comprising sample values of pressure as a function of wave number and time, the time parameter being sample times. Then, for each trace for which there is trace data in the ensemble, typical embodiments of the present invention include stretching in the time dimension the trace data, wherein stretching typically includes using the time stretch tables and interpolating a value of P(kₓ,k_{y},t) at an intermediate time position between two sample times for unstretched trace data.

Typical embodiments of the present invention include, for each migration stage, padding the stretched trace data with zeros to the next mixed radix length; performing a fast fourier transform (“FFT”) to transform the padded trace data from the time domain to the frequency domain; calculating a migration velocity according to

V^{mig}=((Vₙ^{ref})²−(Vₙ₋₁^{ref})²)^{½};

performing on the padded trace data an f-k migration using V^{mig}, wherein a first portion of the padded trace data is fully migrated and a second portion of the padded trace data is partially migrated; performing an inverse FFT to transform all of the migrated trace data from the frequency domain to the time domain; stripping from the migrated trace data the first, fully migrated, portion of the migrated trace data; and shifting earlier in time the second, partially migrated, portion of the migrated trace data. After completion of the last partial migration stage, typical embodiments of the present invention include unstretching in the time dimension the trace data, wherein unstretching includes using the time stretch tables and interpolating a value of P(kₓ,k_{y},T) at an intermediate time position between two stretch times for stretched, migrated trace data.

Typical embodiments of the present invention include establishing a laterally-averaged interval velocity profile from RMS velocity (V_{RMS}), extending from the surface to time t includes the steps of re-sampling the RMS velocity profiles in a seismic survey in the vertical (time) dimension with a specified interval; on each sample point level, averaging the RMS velocities from all velocity profiles on this level, resulting in a laterally-averaged RMS velocity profile; and converting the averaged RMS velocity on each sample point into the interval velocity according to the following formula, resulting in a laterally-averaged interval velocity profile. The following formula is referred to in this specification as the “Dix formula,” after C. H. Dix's “Seismic Velocities from Surface Measurements,” Geophysics, Vol. 20, No. 1, p.73 (1955). The Dix formula is:

Vₙ=(TₙVₙ²−(Tn−1)(Vn−1)²)/(Tₙ−Tₙ₋₁),

where Vₙ and Vₙ₋₁ are average velocities from the surface to the bottom of layers “n” and “n−1,” respectively. The two-way travel times from the surface to the bottom of each layer are Tₙ and Tₙ₋₁. In typical embodiments, the Dix formula enables the inference of the interval velocity for the nth layer, Vₙ, from this information. The interval velocity typically is considered constant over the layer. It is typical also to assume that estimates of Vₙ and Vₙ₋₁ are well-approximated by the RMS velocity estimates as obtained from hyperbolic velocity analysis.

In typical embodiments of the present invention, true, rather than optimally fitted interval velocity Vₙ is extracted from input average or RMS velocities. This extraction is typically accomplished by use of the Dix formula. It is the resulting profile of Vₙ versus time (or depth) that is then typically used to obtain a depth versus time curve.

Typical embodiments of the present invention include determining layer boundaries through the further steps of integrating the laterally-averaged, interval velocity profile to obtain a computed depth for each measured travel time sample; grouping the sample pairs of depth and travel time into N candidate subdivisions; applying linear regression over each such subdivision; computing the sum of the squares of the residuals between the original sample depths and the linearly-fitted depths and iterating over a subset of all possible such sets of subdivisions in order to identify the unique set that gives rise to minimum sum of squares of residuals for the N subdivisions. The subset of all possible sets of subdivisions is found through ‘dynamic programming,’ example pseudocode for which is set forth in Exhibit II to this specification. The example of dynamic programming set forth in Exhibit II is an example of a way of determining layer boundaries. Other ways of determining layer boundaries will occur to those of skill in the art, all such ways being well within the scope of the present invention.

Typical embodiments of the present invention include generating interpolation coefficient tables, including specifying the number of pre-selected positions in a sample interval and the interpolation filter length; on each pre-selected sample point, determining the fractional sample interval δn (0.0<=δn<=1.0); calculating the interpolation coefficients of the specified length by use of the analytical interpolation filter formula, typically for a windowed sinc filter; and storing the calculated coefficients in a two-dimensional table, with the length of the first dimension being the number of pre-selected positions and the length of the second dimension being the interpolation filter length. Typical embodiments of the present invention include generating a time stretch table further comprising generating a table of RMS velocities V_{RMS}, unstretched time t, and stretched time T according to

$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′} ,$$

where t is an unstretched vertical travel time, T is a stretched time corresponding to an unstretched vertical travel time, t′ is a variable of integration, V_{RMS}^{ref} is an RMS velocity corresponding to a laterally-averaged interval velocity, and V_{RMS} is an RMS velocity corresponding to a true interval velocity.

Typical embodiments of the present invention include stretching in the time dimension the trace data comprises the further steps of finding, for a stretched time on an integral sample interval, the corresponding unstretched time in the time stretch table, based on the combination of interval velocity and stretched time in the data; obtaining the sample value at the unstretched time that usually does not fall onto the integral sample points, by interpolation using the interpolation coefficient table described above; and assigning the value obtained by the interpolation to the stretched time. Typical embodiments of the present invention include performing an f-k migration including determining ωₘᵢₙ and ωₘₐₓ; determining \overline{ω}ₘᵢₙ and \overline{ω}ₘₐₓ, wherein there are a finite number of \overline{ω}'s between \overline{ω}ₘᵢₙ and \overline{ω}ₘₐₓ; and performing for each \overline{ω} between \overline{ω}ₘᵢₙ and \overline{ω}ₘₐₓ the steps of computing ω as a function of \overline{ω}, performing windowed sinc interpolation to get Pₘ(\overline{ω}), and scaling Pₘ(\overline{ω}).

Typical embodiments of the present invention include unstretching the trace data comprises the further steps of finding, for an unstretched time on an integral sample interval, in the time stretch table the corresponding stretched time, based on the combination of interval velocity and unstretched time in the data; obtaining the sample value at the stretched time that usually does not fall onto the integral sample points, by interpolation using the interpolation coefficient table described above; and assigning the value obtained by the interpolation to the unstretched time.

Additional exemplary embodiments are described in the technical report entitled User Requirements and Design Specifications for Extended Recursive F-K Migration (ERFKMIG) by Jiaxiang Ren and Steve Kelly, dated May 12, 1999, which report is attached to this specification and incorporated in this specification as Exhibit I. It will be understood from the descriptions in this specification that various modifications and changes may be made in embodiments of the present invention without departing from the spirit of the invention. All exemplary embodiments described in this specification are mere examples, not limiting definitions of the invention. It is intended that descriptions in this specification are only for purposes of illustration and are not to be construed in a limiting sense. The scope of this invention should be limited only by the language of the following claims.

[image]

[image]

[image]

[image]

[image]

[image]

[image]

[image]

[image]

[image]

[image]

[image]

What is claimed is:

1. A method of recursive f-k migration of a body of seismic data performed in N stages, the method comprising the steps of:
establishing from an RMS velocity V_{RMS} a laterally-averaged interval velocity profile extending from a surface at time zero to time t;
determining layer boundaries within the laterally averaged interval velocity profile, the said determining further comprising identifying a unique set of pairs of depth and vertical travel time giving rise to a minimum sum of squares of residuals for the N layers;
calculating a reference velocity for each of the N layers;
stretching the entire body of seismic data according to a stretch equation of:
$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′} ;$$
performing, upon the data in each layer of the body of seismic data not yet fully migrated, recursive stages of f-k migration; and
inversely stretching the entire body of seismic data according to the stretch equation.

2. The method of claim 1 wherein the layer boundaries are identified as vertical travel times t₁ . . . t_{N} for N layers.

3. The method of claim 1 wherein the layer boundaries define layers within the laterally averaged interval velocity profile and within the body of seismic data.

4. The method of claim 1 wherein a jth layer within the body of seismic data contains a portion of seismic data having vertical travel times between tⱼ₋₁ and tⱼ.

5. The method of claim 1 wherein performing recursive stages of f-k migration further comprises using as input to a current recursive migration stage that portion of the output from a previous recursive migration stage that comprises data partially migrated.

6. The method of claim 1 wherein performing recursive stages of f-k migration further comprises repeatedly performing recursive stages of f-k migration until the entire body of seismic data is fully migrated.

7. The method of claim 1 further comprising reading an ensemble of data having constant wave number, the data in the ensemble comprising trace data from a multiplicity of traces, the data in the ensemble comprising sample values of pressure as a function of wave number and time, the time parameter being sample times having intervals when sample values were acquired.

8. The method of claim 1 further comprising performing on the padded trace data a jth stage of recursive f-k migration using as a migration velocity for the jth stage Vⱼ^{mig}, wherein a first portion of the seismic data is fully migrated and a second portion of the seismic data is partially migrated.

9. The method of claim 3 further comprising stripping from the migrated trace data the first, fully migrated, portion of the migrated trace data.

10. The method of claim 4 further comprising shifting earlier in time the second, partially migrated, portion of the migrated trace data.

11. The method of claim 1 wherein stretching the entire body of seismic data according to the stretch equation further comprises the steps of:
generating interpolation coefficient tables comprising interpolation coefficients tabulated for a pre-selected set of positions, δn;
generating a time stretch table, the time stretch table comprising values of stretch time T tabulated according to unstretched time t and V_{RMS}; and
using the time stretch tables and interpolating a value of P(kₓ,k_{y},t) at an intermediate time position between two sample times for unstretched trace data.

12. The method of claim 6 wherein inversely stretching the entire body of seismic data according to the stretch equation further comprises using the time stretch tables and interpolating a value of P(kₓ,k_{y},T) at an intermediate time position between two stretch times for stretched, migrated trace data.

13. The method of claim 1 wherein establishing from an RMS velocity V_{RMS} a laterally-averaged interval velocity profile extending from the surface at time zero to time t, comprises the further steps of:
re-sampling the RMS velocity profiles in a seismic survey in a vertical travel time dimension with a specified interval;
on each of a multiplicity of sample point levels, averaging RMS velocities from all velocity profiles on each sample point level, resulting in a laterally-averaged RMS velocity profile;
converting the averaged RMS velocity on each sample point into the interval velocity according to:
Vₙ=(TₙVₙ²−(Tn−1)(Vn−1)²)/(Tₙ−Tₙ₋₁),
where Vₙ and Vₙ₋₁ are average velocities from the surface to the bottom of layers “n” and “n−1,” respectively.

14. The method of claim 1 wherein determining layer boundaries comprises the further step of:
integrating the laterally-averaged interval velocity profile to obtain a computed depth for each measured vertical travel time in the body of seismic data, the computed depth and the measured vertical travel time for which the computed depth is computed comprising a depth-travel time pair,
grouping the depth-travel time pairs into N candidate subdivisions identified by candidate layer boundaries;
calculating linearly-fitted depths by applying linear regression over each of the N candidate subdivisions,
computing the sum of the squares of the residuals between the computed depths and the linearly-fitted depths; and
identifying a unique set of layer boundaries that gives rise to a minimum sum of squares of residuals for the N subdivisions by iterating over a subset of all possible such sets of candidate subdivisions identified by candidate layer boundaries.

15. The method of claim 3 wherein choosing a breakpoint configuration comprises the further steps of:
generating stage configurations for all possible combinations of measured vertical travel time and depth; and
searching the generated stage configurations for a stage configuration comprising the minimum value for an objective function expressed as:
Φ(m,S,E)=^{m}Σₖ₌₁^{E(k)}Σⱼ₌ₛ₍ₖ₎[Tⱼ−T′(zⱼ)]²
wherein Tⱼ is the true two-way travel time to depth Zⱼ and T′(zⱼ) is a linearly-fitted two-way travel time from a linear regression of depth versus vertical travel time.

16. The method of claim 1 wherein calculating reference velocities comprises the further steps of:
integrating the laterally-averaged interval velocity profile to obtain a computed depth for each measured vertical travel time in the body of seismic data, the computed depth and the measured vertical travel time for which the computed depth is computed comprising a depth-travel time pair,
grouping the depth-travel time pairs into N layers identified by layer boundaries;
calculating linearly-fitted depths by applying linear regression over each of the N layers,
calculating for each of the N layers a reference velocity as a slope of a function defined by linearly-fitted depth-travel time pairs for each layer.

17. The method of claim 1 wherein generating interpolation coefficient tables comprises the further steps of:
specifying a number of pre-selected sample points in a sample interval and an interpolation filter length;
on each pre-selected sample point, determining the fractional sample interval δn such that 0.0<=δn<=1.0;
calculating an interpolation coefficient for each specified sample point, including using an analytical interpolation filter comprising a windowed sinc filter, the interpolation filter having an interpolation filter length; and
storing the calculated interpolation coefficients in a two-dimensional table, with the length of the first dimension being the number of pre-selected positions and the length of the second dimension being the interpolation filter length.

18. The method of claim 1 wherein generating a time stretch table further comprises generating a table of RMS velocities V_{RMS}, unstretched time t, and stretched time T according to:
$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′}$$
wherein
t is an unstretched vertical travel time,
T is a stretched time corresponding to an unstretched vertical travel time,
t′ is a variable of integration,
V_{RMS}^{ref} is an RMS velocity corresponding to a laterally-averaged interval velocity, and
V_{RMS} is an RMS velocity corresponding to a true interval velocity.

19. The method of claim 6 wherein stretching the entire body of seismic data comprises the further steps of:
for a first sample stretched time and an RMS velocity in an integral sample interval, wherein the first sample stretched time has a value falling between integral sample points, finding in the time stretch table a corresponding unstretched time t, wherein the corresponding unstretched time does fall precisely upon an integral sample point;
obtaining a second sample stretched time interpolating using the interpolation coefficient table in dependence upon the corresponding unstretched time; and
assigning the value of the second sample stretched time obtained by the interpolation as an actual stretched time value.

20. The method of claim 1 wherein the performing an f-k migration comprises the further steps of:
determining ωₘᵢₙ and ωₘₐₓ;
determining \overline{ω}ₘᵢₙ and \overline{ω}ₘₐₓ, wherein there are a finite number of \overline{ω}'s between \overline{ω}ₘᵢₙ and \overline{ω}ₘₐₓ;
performing for each \overline{ω} between \overline{ω}ₘᵢₙ and \overline{ω}ₘₐₓ the following steps:
computing ω as a function of \overline{ω};
performing windowed sinc interpolation to get Pₘ(\overline{ω}); and
scaling Pₘ(\overline{ω}).

21. The method of claim 1 wherein stripping the fully migrated portion of the migrated trace data further comprises concatenating a fully migrated portion of trace data from a stage of recursive migration with the fully migrated data from previous stages of recursive migration.

22. The method of claim 6 wherein inversely stretching the entire body of seismic data comprises the further steps of:
for an unstretched time on an integral sample interval, finding in the time stretch table a corresponding stretched time, based on the combination of interval velocity and unstretched time in the data;
obtaining the sample value at the stretched time, wherein the sample value falls between integral sample points, further comprising interpolating by use of the interpolation coefficient tables; and
assigning the value obtained by the interpolation as an unstretched time.

23. A computer system for recursive f-k migration of a body of seismic data performed in N stages, the system comprising:
means for establishing from an RMS velocity V_{RMS} a laterally-averaged interval velocity profile extending from a surface at time zero to time t;
means for determining layer boundaries within the laterally averaged interval velocity profile, the said means for determining layer boundaries further comprising means for identifying a unique set of pairs of depth and vertical travel time giving rise to a minimum sum of squares of residuals for the N layers; the layer boundaries defining layers within the laterally averaged interval velocity profile and within the body of seismic data, the jth layer within the body of seismic data containing the portion of seismic data having vertical travel times between tⱼ₋₁ and tⱼ;
means for calculating reference velocities, the reference velocities including one reference velocity for each of the N layers;
means for stretching the entire body of seismic data according to a stretch equation of:
$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′} ;$$
means for performing, upon the data in each layer of the body of seismic data not yet fully migrated, recursive stages of f-k migration, including means for using as input to a current recursive migration stage that portion of the output from a previous recursive migration stage that comprises data partially migrated, further including means for using for the migration velocity for a jth recursive migration stage a migration velocity defined as Vⱼ^{mig}=((Vⱼ^{ref})²−(Vⱼ₋₁^{ref}(²)^{½}; further including means for repeatedly performing recursive stages of f-k migration until the entire body of seismic data is fully migrated; and
means for inversely stretching the entire body of seismic data according to the stretch equation.

24. The system of claim 18 further comprising means for reading an ensemble of data having constant wave number, the data in the ensemble comprising trace data from a multiplicity of traces, the data in the ensemble comprising sample values of pressure as a function of wave number and time, the time parameter being sample times having intervals when sample values were acquired.

25. The system of claim 18 further comprising means for performing on the padded trace data a jth stage of recursive f-k migration using as a migration velocity for the jth stage Vⱼ^{mig}, wherein a use of the means for performing a jth stage of recursive f-k migration a first portion of the seismic data is fully migrated and a second portion of the seismic data is partially migrated.

26. The system of claim 20 further comprising means for stripping from the migrated trace data the first, fully migrated, portion of the migrated trace data.

27. The system of claim 21 further comprising means for shifting earlier in time the second, partially migrated, portion of the migrated trace data.

28. The system of claim 18 wherein means for stretching the entire body of seismic data according to the stretch equation further comprises:
means for generating interpolation coefficient tables comprising interpolation coefficients tabulated for a pre-selected set of positions, δn;
means for generating a time stretch table, the time stretch table comprising values of stretch time T tabulated according to unstretched time t and V_{RMS}; and
means for using the time stretch tables and interpolating a value of P(kₓ,k_{y},t) at an intermediate time position between two sample times for unstretched trace data.

29. The system of claim 23 wherein means for inversely stretching the entire body of seismic data according to the stretch equation further comprises means for using the time stretch tables and interpolating a value of P(kₓ,k_{y},T) at an intermediate time position between two stretch times for stretched, migrated trace data.

30. The system of claim 18 wherein means for establishing from an RMS velocity V_{RMS} a laterally-averaged interval velocity profile extending from the surface at time zero to time t, further comprises:
means for re-sampling the RMS velocity profiles in a seismic survey in a vertical travel time dimension with a specified interval;
means for averaging, on each of a multiplicity of sample point levels, RMS velocities from all velocity profiles on each sample point level, resulting in a laterally-averaged RMS velocity profile;
means for converting the averaged RMS velocity on each sample point into the interval velocity according to:
Vₙ=(TₙVₙ²−(Tn−1)(Vn−1)²)/(Tₙ−Tₙ₋₁),
where Vₙ and Vₙ₋₁ are average velocities from the surface to the bottom of layers “n” and “n−1,” respectively.

31. The system of claim 18 wherein means for determining layer boundaries comprises:
means for integrating the laterally-averaged interval velocity profile to obtain a computed depth for each measured vertical travel time in the body of seismic data, the computed depth and the measured vertical travel time for which the computed depth is computed comprising a depth-travel time pair,
means for grouping the depth-travel time pairs into N candidate subdivisions identified by candidate layer boundaries;
means for calculating linearly-fitted depths by applying linear regression over each of the N candidate subdivisions,
means for computing the sum of the squares of the residuals between the computed depths and the linearly-fitted depths;
means for identifying a unique set of layer boundaries that give rise to a minimum sum of squares of residuals for the N subdivisions by use of
means for iterating over a subset of all possible such sets of candidate subdivisions identified by candidate layer boundaries.

32. The system of claim 20 wherein means for choosing a breakpoint configuration further comprises:
means for generating stage configurations for all possible combinations of measured vertical travel time and depth; and
means for searching the generated stage configurations for a stage configuration comprising the minimum value for an objective function expressed as:
Φ(m,S,E)=^{m}Σₖ₌₁^{E(k)}Σⱼ₌ₛ₍ₖ₎[Tⱼ−T′(zⱼ)]²
wherein Tⱼ is the true two-way travel time to depth Zⱼ and T′(zⱼ) is a linearly-fitted two-way travel time from a linear regression of depth versus vertical travel time.

33. The system of claim 18 wherein means for calculating reference velocities further comprises:
means for integrating the laterally-averaged interval velocity profile to obtain a computed depth for each measured vertical travel time in the body of seismic data, the computed depth and the measured vertical travel time for which the computed depth is computed comprising a depth-travel time pair,
means for grouping the depth-travel time pairs into N layers identified by layer boundaries;
means for calculating linearly-fitted depths by use of means for means for linear regression over each of the N layers,
means for calculating for each of the N layers a reference velocity as a slope of a function defined by linearly-fitted depth-travel time pairs for each layer.

34. The system of claim 18 wherein means for generating interpolation coefficient tables further comprises:
means for specifying a number of pre-selected sample points in a sample interval and an interpolation filter length;
means for determining, on each pre-selected sample point, the fractional sample interval on such that 0.0<=δn<=1.0;
means for calculating an interpolation coefficient for each specified sample point, further including means for using an analytical interpolation filter comprising a windowed sinc filter, the interpolation filter having an interpolation filter length; and
means for storing the calculated interpolation coefficients in a two-dimensional table, with the length of the first dimension being the number of pre-selected positions and the length of the second dimension being the interpolation filter length.

35. The system of claim 18 wherein means for generating a time stretch table further comprises means for generating a table of RMS velocities V_{RMS}, unstretched time t, and stretched time T according to:
$${\int }_{0}^{T} {{t}^{′} [ {V}_{RMS}^{ref} ( {t}^{′} ) ]}^{2} ⅆ {t}^{′} = {\int }_{0}^{t} {{t}^{′} [ {V}_{RMS} ( {t}^{′} ) ]}^{2} ⅆ {t}^{′}$$
wherein
t is an unstretched vertical travel time,
T is a stretched time corresponding to an unstretched vertical travel time,
t′ is a variable of integration,
V_{RMS}^{ref} is an RMS velocity corresponding to a laterally-averaged interval velocity, and
V_{RMS} is an RMS velocity corresponding to a true interval velocity.

36. The system of claim 23 wherein means for stretching the entire body of seismic data further comprises:
means for finding, for a first sample stretched time and an RMS velocity in an integral sample interval, wherein the first sample stretched time has a value falling between integral sample points, in the time stretch table a corresponding unstretched time t, wherein the corresponding unstretched time does fall precisely upon an integral sample point; and
means for obtaining a second sample stretched time interpolating using the interpolation coefficient table in dependence upon the corresponding unstretched time; and
means for assigning the value of the second sample stretched time obtained by the interpolation as an actual stretched time value.

37. The system of claim 18 wherein means for performing an f-k migration further comprises:
means for determining (ωₘᵢₙ and ωₘₐₓ;
means for determining \overline{ω}ₘᵢₙ and \overline{ω}ₘₐₓ, wherein there are a finite number of \overline{ω}'s between \overline{ω}ₘᵢₙ and \overline{ω}ₘₐₓ; and
means, capable of application to each \overline{ω} between \overline{ω}ₘᵢₙ and \overline{ω}ₘₐₓ, for:
computing ω as a function of \overline{ω};
performing windowed sinc interpolation to get Pₘ(\overline{ω}); and
scaling Pₘ(\overline{ω}).

38. The system of claim 18 wherein means for stripping the fully migrated portion of the migrated trace data further comprises means for concatenating a fully migrated portion of trace data from a stage of recursive migration with the fully migrated data from previous stages of recursive migration.

39. The system of claim 23 wherein means for inversely str etching the entire body of seismic data comprises the further steps of:
means for finding, for an unstretched time on an integral sample interval, in the time stretch table a corresponding stretched time, based on the combination of interval velocity and unstretched time in the data;
means for obtaining the sample value at the stretched time, wherein the sample value falls between integral sample points, further comprising means for interpolating by use of the interpolation coefficient tables; and
means for assigning the value obtained by the interpolation as an unstretched time.
